(19) United States
(12) Patent Application Publication
(10) Pub. No.: US 2020/0309031 A1
(43) Pub. Date: Oct. 1, 2020

(54) SLIDING BEARING DEVICE, A METHOD FOR OPERATING A SLIDING BEARING DEVICE AND A GAS TURBINE ENGINE

(71) Applicant: Rolls-Royce Deutschland Ltd & Co KG, Blankenfelde-Mahlow (DE)

(72) Inventor: Rudolf LÜCK, Rehbrucke (DE)

(21) Appl. No.: 16/795,204

(22) Filed: Feb. 19, 2020

(30) Foreign Application Priority Data
Mar. 29, 2019 (DE) 10 2019 204 507.3

(51) Int. Cl. F02C 7/06; F02C 7/36

(52) U.S. Cl. CPC F02C 7/06; F05D 2240/60; F05D 2240/50; F02C 7/36

(57) ABSTRACT

The invention relates to a plain bearing device having a primary sliding surface between a first pair of concentrically arranged structural elements, wherein, in a normal operating state, a relative rotational movement between the structural elements along the primary sliding surface is possible, characterized by at least one secondary sliding surface between a second pair of concentrically arranged structural elements, wherein a coupling means, in the normal operating state, prevents a relative rotational movement between the second pair of structural elements, and wherein, if a predeterminable event occurs, the coupling means is automatically releasable, such that a relative rotational movement between the second pair of structural elements along the at least one secondary sliding surface is made possible. The invention furthermore relates to a method for operating a plain bearing device, and to a gas turbine engine.

This application claims priority to German Patent Application DE102019204507.3 filed Mar. 29, 2019, the entirety of which is incorporated by reference herein.

The present disclosure relates to a plain bearing device having the features of claim 1, to a method for operating a plain bearing device having the features of claim 12 and to a gas turbine engine having the features of claim 16.

The wear of plain bearings from the initial identification of impending wear to the point of total failure may occur within seconds. Plain bearing devices which permit or can identify emergency running operation are known for example from DE 20 2016 102 133 U1 or DE 10 2014 200 725 A1.

Below, embodiments will be described which are intended to improve these known devices, in particular with regard to use in a gas turbine engine.

According to a first aspect, a plain bearing device is provided. Said plain bearing device has a primary sliding surface between a first pair of concentrically arranged structural elements, wherein, in a normal operating state, a relative rotational movement between the structural elements along the primary sliding surface is possible, which corresponds to the basic function of a plain bearing.

Furthermore, the plain bearing device has at least one secondary sliding surface between a second pair of concentrically arranged structural elements, wherein a coupling means, in the normal operating state, prevents a relative rotational movement between the second pair of structural elements, and wherein, if a predeterminable event occurs, the coupling means is automatically releasable, such that a relative rotational movement between the second pair of structural elements along the at least one secondary sliding surface is made possible.

The at least one secondary sliding surface thus offers a fall-back position for emergency running if a relative rotational movement along the primary sliding surface is no longer possible. The predetermined event, for example the exceedance of a threshold for the torque, causes the correspondingly designed coupling means to brake or release, and the rotational movement along the secondary sliding surface is made possible.

Here, the predeterminable event for the release of the coupling means may be a deficiency in a lubricant supply to the primary sliding surface, a temperature increase, an increase in the acting torque and/or an at least partial running-dry of the primary sliding surface, wherein the event occurs in particular over a predefined length of time.

The event occurs in each case if a threshold value or multiple predetermined threshold values for a variable (for example torque, temperature etc.) are exceeded. The condition may also be a product of the torque and the temperature; for example, in the presence of high temperatures, even a relatively low torque is sufficient.

Here, in one embodiment, the coupling means may have at least one predetermined breaking point which releases in the event of an exceedance of a particular torque acting thereon, such that a relative rotational movement between the structural elements along the at least one secondary sliding surface is possible.

Here, in one embodiment, the coupling means may have at least one punctiform, axially linear and/or areal connecting point between the structural elements across the at least one secondary sliding surface. A predetermined breaking point may break for example in the presence of a defined torque and/or above a particular temperature.

In particular, the primary sliding surface may be arranged between a first and a second concentrically arranged structural element, and the secondary sliding surface may be arranged concentrically between the second structural element and a third structural element situated further to the inside. The second component is thus a type of intermediate ring between the first structural element at the outside and the third structural element at the inside.

Here, in one embodiment, a filling as coupling means and/or for emergency lubrication after the occurrence of the event is arranged between the structural elements in the region of the at least one secondary sliding surface. The filling may for example have graphite, bearing bronze and/or a polymer, in particular Teflon. Depending on the desired design, the filling may be consumed, such that, after the consumption, the gap and the oil feed are free to function as a hydrodynamic bearing. In addition or alternatively, the filling may provide emergency lubrication which is maintained until a controlled deactivation and shutdown. A breakup or release of the filling may occur as a result of the exceedance of a particular torque and/or as a result of the exceedance of a particular temperature.

The actual lubrication with a lubricant is realized via lubricant ducts, wherein the primary sliding surface and the at least one secondary sliding surface are connected via at least one common lubricant duct. Here, the at least one lubricant duct may in particular extend radially outwards from the interior of the plain bearing device. The at least one lubricant duct can thus supply lubricant to primary and secondary sliding surfaces.

For the detection of an emergency running situation, in one embodiment, a detection device for a relative rotational movement along the at least one secondary sliding surface and/or a mechanical failure of the coupling means is provided. A movement along the secondary sliding surface has the effect that a lubricating movement about the primary sliding surface is no longer possible.

Here, the detection device may be coupled at least to a sensor which is designed as an inductive, capacitive, acoustic, microwave or optical sensor.

A further aspect is a method for operating a plain bearing device having a primary sliding surface between a first pair of concentrically arranged structural elements, wherein, in a normal operating state, a relative rotational movement between the structural elements (101, 102) along the primary sliding surface occurs.

Here, at least one secondary sliding surface is initially present between a second pair of concentrically arranged structural elements, wherein, in the normal operating state, a relative rotational movement between the second pair of structural elements is prevented.

If a normal operating state is departed from, that is to say if a predeterminable event occurs, the coupling means is released in targeted and automatic fashion, such that a relative rotational movement between the second pair of structural elements along the at least one secondary sliding surface occurs.

In one embodiment, the event for the release of the coupling means is a deficiency in a lubricant supply to the primary sliding surface, a temperature increase, an increase in the acting torque and/or an at least partial running-dry of the primary sliding surface, wherein the event occurs in particular over a predefined length of time.

Here, in one embodiment, a filling for emergency lubrication may be arranged between the delimiting structural elements in the region of the at least one secondary sliding surface, wherein, after the occurrence of the event, a lubricating film builds up on the secondary sliding surface. To this end, the lubricant is provided by means of the at least one lubricant duct.

In a further embodiment, a relative rotational movement along the at least one secondary sliding surface and/or a release of the coupling means is detected by a detection means, and a corresponding signal is output to a control device to display the emergency running mode that occurs.

It is also possible for a gas turbine engine to have a gear box with at least one plain bearing device having the features of at least one of claims 1 to 11. Here, the gear box may be designed a planetary gear box, wherein all or some of the planet gears are mounted on the planet carrier by means of a plain bearing device according to at least one of claims 1 to 11. Also, the planetary gear box may be coupled to a sensor device which monitors the movement of the planet gears and of the plain bearing devices thereof.

As noted elsewhere herein, the present disclosure may relate to a gas turbine engine, e.g. an aircraft engine. Such a gas turbine engine may comprise a core engine comprising a turbine, a combustor, a compressor, and a core shaft connecting the turbine to the compressor. Such a gas turbine engine may comprise a fan (with fan blades) which is positioned upstream of the core engine.

Arrangements of the present disclosure may be particularly, although not exclusively, beneficial for geared fans, which are driven via a gear box. Accordingly, the gas turbine engine can comprise a gear box which is driven via the core shaft and the output of which drives the fan in such a way that it has a lower speed than the core shaft. The input to the gear box may be directly from the core shaft, or indirectly via the core shaft, for example via a spur shaft and/or gear. The core shaft may be rigidly connected to the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The core engine may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) a flow from the first compressor.

The gear box may be designed to be driven by the core shaft that is configured to rotate (for example during use) at the lowest rotational speed (for example the first core shaft in the example above). For example, the gear box may be designed to be driven only by the core shaft that is configured to rotate (for example during use) at the lowest rotational speed (for example only by the first core shaft, and not the second core shaft, in the example above). Alternatively, the gear box may be designed to be driven by one or more shafts, for example the first and/or second shaft in the example above.

In any gas turbine engine as described and/or claimed herein, a combustor may be provided axially downstream of the fan and compressor or compressors. For example, the combustor may be directly downstream of (for example at the exit of) the second compressor, where a second compressor is provided. By way of further example, the flow at the exit to the compressor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (i.e. the angle of incidence may be variable). The row of rotor blades and the row of stator vanes may be axially offset with respect to each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset with respect to each other.

Each fan blade may have a radial span extending from a root (or hub) at a radially inner gas-washed location, or from a 0% span position, to a tip with a 100% span position. The ratio of the radius of the fan blade at the hub to the radius of the fan blade at the tip may be less than (or of the order of) any of the following: 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range bounded by two values in the previous sentence (i.e. the values may form upper or lower bounds). These ratios may commonly be referred to as the hub-to-tip ratio. The radius at the hub and the radius at the tip may both be measured at the leading edge (or axially forwardmost edge) of the blade. The hub-to-tip ratio refers, of course, to the gas-washed portion of the fan blade, i.e. the portion radially outside any platform.

The radius of the fan may be measured between the engine centreline and the tip of the fan blade at its leading edge. The fan diameter (which may generally be twice the radius of the fan) may be greater than (or of the order of) any of the following: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 cm (around 150 inches) or 390 cm (around 155 inches). The fan diameter may be in an inclusive range bounded by any two of the values in the previous sentence (i.e. the values may form upper or lower bounds).

The rotational speed of the fan may vary in operation. Generally, the rotational speed is lower for fans with a larger diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

During use of the gas turbine engine, the fan (with associated fan blades) rotates about a axis of rotation. This rotation results in the tip of the fan blade moving with a velocity Uₜᵢₚ. The work done by the fan blades on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as fan tip radius at the leading edge multiplied by angular speed). The fan tip loading at cruise conditions may be greater than (or of the order of) any of the following: 0.3, 0.31, 0.32, 0.33, 0.34, 0.35, 0.36, 0.37, 0.38, 0.39 or 0.4 (all units in this paragraph being Jkg⁻¹K⁻¹/(ms⁻¹)²). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or of the order of) any of the following: 10, 10.5, 11, 11.5, 12, 12.5, 13, 13.5, 14, 14.5, 15, 15.5, 16, 16.5 or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or of the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or of the order of) any of the following: 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or of the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15° C. (ambient pressure 101.3 kPa, temperature 30° C.), with the engine static.

During use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or of the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET during use of the engine may be, for example, at least (or of the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off thrust (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which is manufactured using a material that is better able to resist impact (for example from birds, ice or other material) than the rest of the blade. Such a leading edge may, for example, be manufactured using titanium or a titanium based alloy. Thus, purely by way of example, the fan blade may have a carbon-fibre or aluminium based body (such as an aluminium-lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disk). Purely by way of example, such a fixture may be in the form of a dovetail that may slot into and/or engage a corresponding slot in the hub/disk in order to fix the fan blade to the hub/disk. By way of further example, the fan blades may be formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disk by welding, such as linear friction welding.

The gas turbine engines described and/or claimed herein may or may not be provided with a variable area nozzle (VAN). Such a variable area nozzle may allow the exit area of the bypass duct to be varied in operation. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may mean the cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of descent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example of the order of Mach 0.8, of the order of Mach 0.85 or in the range of from 0.8 to 0.85. Any single speed within these ranges may be the cruise condition. For some aircraft, the cruise condition may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example of the order of 11000 m. The cruise conditions may correspond to standard atmospheric conditions at any given altitude in these ranges.

Purely by way of example, the cruise conditions may correspond to the following: a forward Mach number of 0.8; a pressure of 23000 Pa; and a temperature of −55° C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In operation, a gas turbine engine described and/or claimed herein may operate at the cruise conditions defined elsewhere herein. Such cruise conditions may be determined by the cruise conditions (for example the mid-cruise conditions) of an aircraft to which at least one (for example two or four) gas turbine engine(s) may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Embodiments will now be described by way of example, with reference to the figures, in which:

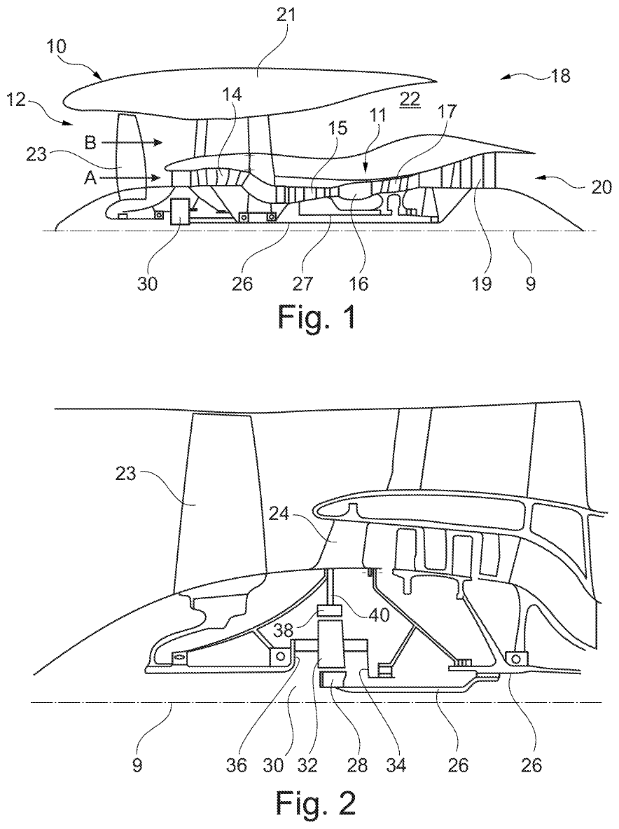

FIG. 1 is a sectional side view of a gas turbine engine;

FIG. 2 is a close up sectional side view of an upstream portion of a gas turbine engine;

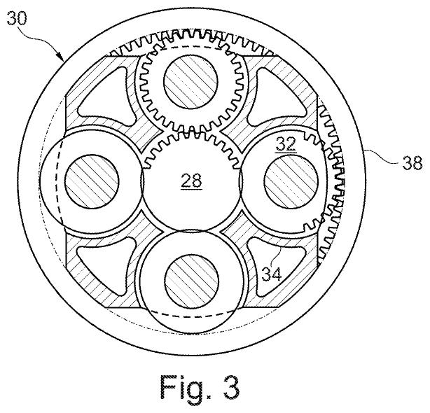

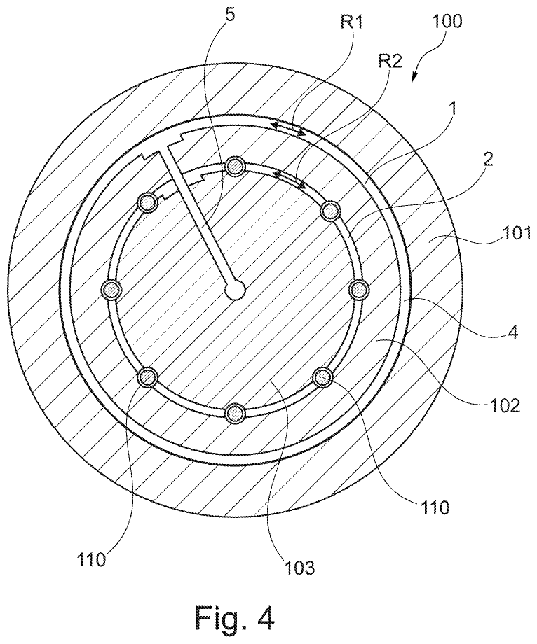

FIG. 3 is a partially cut-away view of a gear box for a gas turbine engine;

FIG. 4 is a section through a first embodiment of a Plain bearing device;

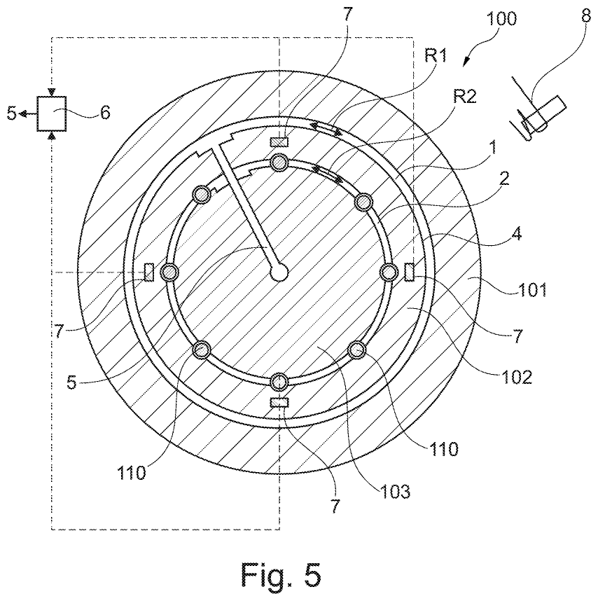

FIG. 5 is a sectional view through a second embodiment of a plain bearing device having a detection device for a relative movement (phonic wheel);

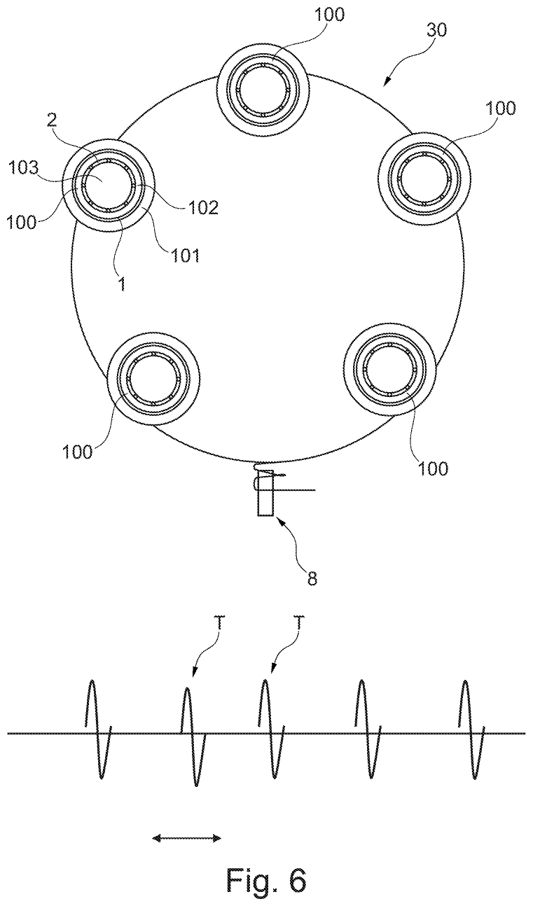

FIG. 6 is a schematic illustration of an inductive signal profile from the determination of a relative movement using the embodiment as per FIG. 5;

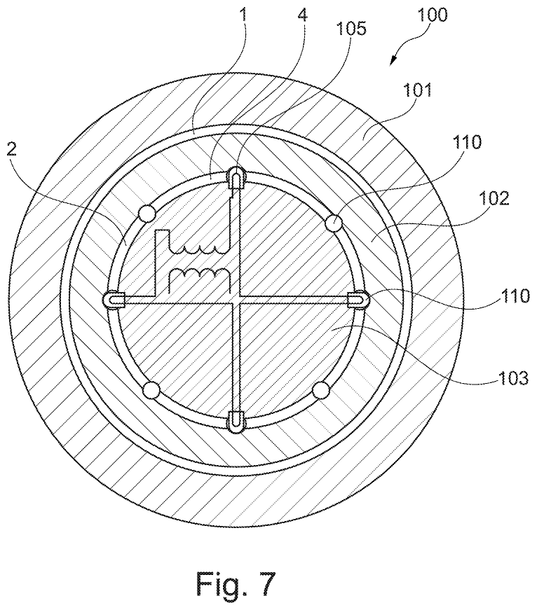

FIG. 7 is a schematic illustration of a third embodiment of a plain bearing device using conductor loops;

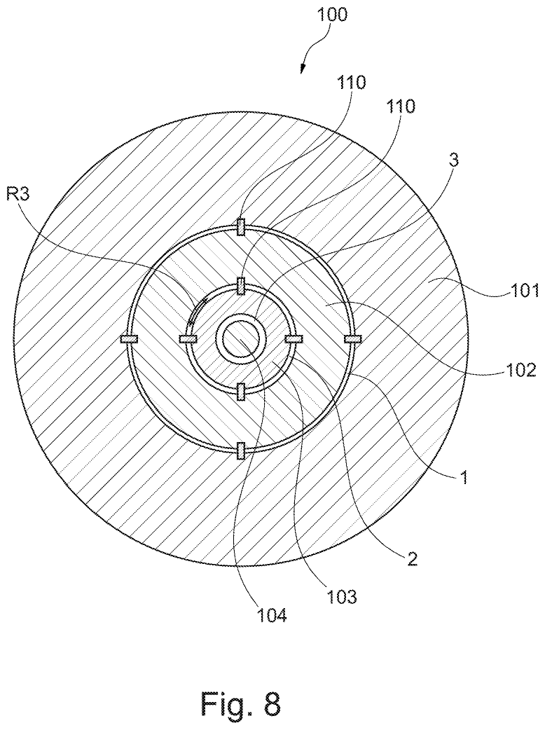

FIG. 8 shows a plain bearing device with two secondary sliding surfaces.

FIG. 1 illustrates a gas turbine engine 10 having a main axis of rotation 9. The gas turbine engine 10 comprises an air intake 12 and a fan 23 that generates two airflows: a core airflow A and a bypass airflow B. The gas turbine engine 10 comprises a core 11 that receives the core airflow A. When viewed in the order corresponding to the axial direction of flow, the core engine 11 comprises a low pressure compressor 14, a high pressure compressor 15, a combustion device 16, a high pressure turbine 17, a low pressure turbine 19 and a core thrust nozzle 20. A nacelle 21 surrounds the gas turbine engine 10 and defines a bypass duct 22 and a bypass thrust nozzle 18. The bypass airflow B flows through the bypass duct 22. The fan 23 is attached to and driven by the low pressure turbine 19 via a shaft 26 and an epicyclic planetary gear box 30.

In operation, the core airflow A is accelerated and compressed by the low pressure compressor 14 and directed into the high pressure compressor 15 where further compression takes place. The compressed air exhausted from the high pressure compressor 15 is directed into the combustion device 16, where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic planetary gear box 30 is a reduction gear box.

An exemplary arrangement for a geared fan gas turbine engine 10 is shown in FIG. 2. The low pressure turbine 19 (see FIG. 1) drives the shaft 26, which is coupled to a sun gear 28 of the epicyclic planetary gear box 30. Radially outwardly of the sun gear 28 and intermeshing therewith is a plurality of planet gears 32 that are coupled together by a planet carrier 34. The planet carrier 34 guides the planet gears 32 in such a way that they precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gear box output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

The epicyclic planetary gear box 30 is shown by way of example in greater detail in FIG. 3. Each of the sun gear 28, planet gears 32 and ring gear 38 comprise teeth on their periphery to allow intermeshing with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of an epicyclic planetary gear box 30 generally comprise at least three planet gears 32.

The epicyclic planetary gear box 30 illustrated by way of example in FIGS. 2 and 3 is a planetary gear box in which the planet carrier 34 is coupled to an output shaft via linkages 36, with the ring gear 38 fixed. However, any other suitable type of planetary gear box 30 may be used. By way of further example, the planetary gear box 30 may be a star arrangement, in which the planet carrier 34 is held fixed, with the ring gear (or annulus) 38 allowed to rotate. In such an arrangement the fan 23 is driven by the ring gear 38. By way of further alternative example, the gear box 30 may be a differential gear box in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gear box 30 in the gas turbine engine 10 and/or for connecting the gear box 30 to the gas turbine engine 10. By way of further example, the connections (such as the linkages 36, 40 in the FIG. 2 example) between the gear box 30 and other parts of the gas turbine engine 10 (such as the input shaft 26, the output shaft and the fixed structure 24) may have a certain degree of stiffness or flexibility. By way of further example, any suitable arrangement of the bearings between rotating and stationary parts of the gas turbine engine 10 (for example between the input and output shafts of the gear box and the fixed structures, such as the gear box casing) may be used, and the disclosure is not limited to the exemplary arrangement of FIG. 2. For example, where the gear box 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gear box styles (for example star or epicyclic-planetary), support structures, input and output shaft arrangement, and bearing locations.

Optionally, the gear box may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 possibly does not comprise a gear box 30.

The geometry of the gas turbine engine 10, and components thereof, is or are defined by a conventional axis system, comprising an axial direction (which is aligned with the axis of rotation 9), a radial direction (in the bottom-to-top direction in FIG. 1), and a circumferential direction (perpendicular to the view in FIG. 1). The axial, radial and circumferential directions are mutually perpendicular.

In a planetary gear box 30 (see in particular FIGS. 2 and 3), it is the case in particular that the planet gears 32 are mounted rotatably on the planet carrier 34 (also referred to as carrier) by means of plain bearing devices 100. Since a planetary gear box 30 must exhibit high operational reliability in particular when used in a gas turbine engine 10, means which detect a failure situation, and/or which permit emergency running of the plain bearing devices 100 in the failure situation, are expedient; an embodiment of a plain bearing device 100 designed for this is illustrated in FIG. 4.

Such a plain bearing device 100 may for example be arranged in a bushing for a planet gear 32, wherein other fields of use are basically also possible.

By contrast to known plain bearing devices, the embodiment illustrated here has two plain bearing surfaces 1, 2; a primary sliding surface 1 and a secondary sliding surface 2. The primary sliding surface 1 is arranged between a first, outer structural element 101 and a second, inner structural element 102.

The structural elements 101, 102 form a first pair of structural elements 101, 102, wherein structural elements 101, 102 are arranged as rings concentrically with respect to one another. This corresponds to the configuration of a plain bearing that is known per se. In the normal operating state, a first relative rotational movement R1 is possible along the first primary sliding surface 1.

Lubrication of the primary sliding surface 1 is realized via a lubricant duct 5, which is led radially outwards from the center of the plain bearing device 100 to the primary plain bearing surface 1. In the embodiment illustrated, the lubricant duct 5 opens at the outside into the intermediate space of the primary sliding surface 1 and intersects the intermediate space around the secondary sliding surface 2. It is basically possible for multiple lubricant ducts 5 to be provided, which may also have more complex forms.

Arranged concentrically radially within the second structural element 102 is a third structural element 103, which second structural element and third structural element are mechanically connected to one another by coupling means 110 and together form a second pair of structural elements 102, 103. In the normal operating state, the second pair of structural elements 102, 103 forms a unit, that is to say no relative rotational movements are possible between the structural elements 102, 103.

The coupling means 110 may for example have punctiform or linear positively locking and/or cohesive connections, which release in targeted fashion in the manner of a predetermined breaking point in the presence of a particular load. The coupling means 110 may also be in the form of bars which, together with depressions, give rise to a positively locking action. It is basically also possible for the coupling means 110 to be in the form of a filling along the secondary sliding surface 2.

If a failure, for example a blockage, now occurs in the plain bearing device 100 along the primary sliding surface 1 (for example as a result of a loss of lubrication or breakage event), the rotational movement of the plain bearing device 100 is blocked. Such a blockage may be caused for example by a predetermined event, such as for example the exceedance of a particular torque value acting in the plain bearing device 100. As a result, in the embodiment illustrated, the mechanical connection by the coupling means 110 between the second and third structural elements 102, 103 is automatically released. This may be effected for example as a result of the breakage of the abovementioned predetermined breaking point in the coupling means 110.

It is thus then the case—as a substitute for the blocked primary sliding surface 1—that a relative rotational movement R2 along the secondary sliding surface 2 is possible. This performs the function of the primary sliding surface 1 in an alternative manner. Emergency running even in the event of failure of the primary sliding surface can thus be ensured.

Robust mechanical automatism is thus realized, because a relative movement R2 along the secondary sliding surface 2 compulsorily indicates that the movement along the primary sliding surface 1 is no longer nominal. If, for example at this juncture, one were to rely on signals with an associated signal/noise ratio, then uncertainty would arise as to whether a defective plain bearing is actually present and, for example, a shutdown of the gas turbine engine 10 is justified. If the intermediate ring moves, the plain bearing device 100 in any case exhibits damage, and will function only for a particular period of time.

A filling 4, for example composed of bearing bronze, graphite and/or a polymer, in particular Teflon, is arranged in the intermediate space between the second structural element 102 and the third structural element 103, that is to say in the region of the secondary sliding surface 2. In the normal operating state, that is to say when the coupling means 110 is intact, the filling 4 (and/or the coupling means 110) transmits torques over the full surface area.

Immediately after the blockage at the primary sliding surface 1 and the release of the secondary sliding surface 2, the filling 4 serves for promoting a start-up with reduced friction. After a certain period of time, as a result of the radially running lubricant duct 5, a lubricating film will build up along the secondary sliding surface 2, which lubricating film then permits emergency running of the plain bearing device 100. A feed of a lubricant (for example oil) would remain possible after the rotation relative to the primary sliding surface 1 if a groove (in a circumferential direction) as an oil guide were provided in the primary sliding surface 1.

FIG. 5 illustrates a refinement of the embodiment from FIG. 4, such that reference can be made to the corresponding description.

Additionally, here, a detection device 6 (only schematically illustrated here) is provided in the plain bearing device 100, with which detection device the occurrence of the emergency running function, that is to say the departure from the normal operating state, can be identified.

For this purpose, in the second structural element 102, that is to say the central ring of the plain bearing device 100, there are arranged ferromagnetic teeth 7. In the embodiment illustrated, four ferromagnetic teeth 7 are arranged offset in each case by 90° in a plane. In other embodiments, it is also possible for fewer or more ferromagnetic teeth 7 to be used, wherein it is basically also the case that a symmetrical arrangement is not imperative.

The ferromagnetic teeth 7 (schematically illustrated in FIG. 5) are intended to identify when a relative rotational movement R2 along the secondary sliding surface 2 occurs, that is to say if the plain bearing device 100 enters the emergency running mode.

In the illustrated embodiment, the ferromagnetic teeth 7′ of a phonic wheel are formed on the intermediate ring 102, with which relative changes in position can be identified. A phonic wheel has an arrangement of ferromagnetic teeth 7 (magnet elements would also be an option), which may be relatively movable (that is to say, in this case, after the occurrence of the event and the start of the emergency running mode). The passage of a ferromagnetic tooth 7 past the stationary sensor 8 (see also FIG. 6 above; there may also be multiple inductive sensors) results in a change in the magnetic flux in the sensor 8. In this way, a voltage is induced in the sensor 8, which voltage can be measured. If the emergency running of a bearing has commenced, the timing of the signals generated by the teeth on the planet gears 32 changes (bottom of FIG. 6). If no tooth of the plain bearing which is in the emergency running state is passed over, the signal of said planet gear 32 is omitted.

In the normal operating state, there is no relative rotational movement R2 along the secondary sliding surface 2.

It is basically also possible in alternative embodiments for ultrasound sensors, optical sensors, microwave sensors and/or acoustic sensors to be used as sensors 8. All of the sensors 8 can identify the occurrence of a relative rotational movement R2 in the secondary sliding surface 2.

FIG. 6 schematically illustrates an embodiment of a planetary transmission 30 with five planet gears 32 (not illustrated here), each using embodiments of a plain bearing device 100. Here, the five plain bearing devices 100 have primary and secondary sliding surfaces 1, 2, which is illustrated here merely schematically for the sake of clarity.

Here, the sensor device 8 has inductive sensors (only one is illustrated here) which are arranged at fixed positions of the planetary gear box 30 (not illustrated here). Thus, in each case, the passage of the ferromagnetic teeth 7 or of the magnet elements of the various (see for example FIG. 5) structural elements 102, 104 of the plain bearing devices 100 of the various planet gears 32 is detected.

In the case of equidistant intervals of the signals T (as illustrated in the lower part of FIG. 6) of the sensors, no emergency running function is triggered.

In the event of a variation of the equidistant intervals of the read-out sensor signals or the absence of a signal, an emergency running function is commenced, as illustrated by the double arrow at one signal.

In the nominal state, the intermediate ring (in this case the second structural element 102) is connected to the axle of the planet carrier 34. This has the result that phonic wheels on the intermediate ring 102 always run with the same tooth past the stationary external inductive sensor 8. Signals are thus generated with a consistent interval. If emergency running of the plain bearing device 100 has been activated, the time relationship of the signals with respect to one another changes. The signal of the plain bearing device 100 that is in the emergency running state continuously changes the phase position relative to the signals of the other planet gears 32, or is omitted, because a position with an elevation of the phonic wheel is not passed over.

A further embodiment of a plain bearing device 100 is illustrated in FIG. 7. Here, the secondary sliding surface 2 is arranged concentrically within the primary sliding surface 1.

Here, to identify the emergency running function, conductor loops 105 are led through at least one of the fixed points of the coupling means 110. The conductor loops 105 may for example be embedded in material (for example ceramic).

Said material is fixedly connected to the coupling means 110, such that an interruption of the conductor loops 105 occurs in the event of breakage of the connections upon the occurrence of the event. In the normal operating state, a current is conducted through the conductor loops 105. If said current is interrupted, the emergency running function is identified.

If a relative movement R2 along the secondary sliding surface 2 occurs as a result of the breakage of the connection 105, a change in the current in the stationary part of the transmitter (105) occurs. The inner, third structural element 103 with the associated coils is at a standstill, and the second, outer structural element 102 with the associated coils rotates. An alternating current is fed into the stationary part. If a breakage of a conductor loop occurs on the rotating bearing side, a difference in the current/voltage relationship on the feeding, stationary side can be detected. This involves a two-part transmitter, in the case of which one part rotates and one part is stationary.

In the case of planetary gear boxes 30 in which the planet gears 32 revolve, the current can be transmitted between rotating and stationary parts by means of coils. In this case, alternating current must be used for feed purposes.

If the solution with wires (conductor loops 105) in the coupling means 110 is used, it would suffice for one coupling means 110 with one wire to break. In the case of the solution with the phonic wheel (see FIG. 5), it is necessary for all predetermined breaking points to break in order that the intermediate ring can move and said movement can be identified by means of an external inductive sensor 8.

FIG. 8 schematically illustrates a further development of an embodiment of a plain bearing device 100. This substantially corresponds to the embodiments as per FIG. 4, 5 or 7, wherein, here, for the sake of clarity, the lubricant ducts 5 and other details have been omitted. Reference can be made to the corresponding description.

The embodiments hitherto illustrated have a secondary sliding surface 2, wherein the embodiment of FIG. 8 has two secondary sliding surfaces 2, 3. The second secondary sliding surface 3 is in this case arranged concentrically within the third structural element 103 and extends around a fourth structural element 104. The third and fourth structural elements 103, 104 are connected by coupling means 110.

Here, the first secondary sliding surface 2 is used as already described above, that is to say the second and the third structural element 102, 103 form a first pair of concentrically arranged structural elements.

If a blockage also occurs along the first secondary sliding surface 2, the coupling means 110 along the second secondary sliding surface 3 will automatically break up, such that a relative rotational movement R3 is now possible. The third and the fourth structural elements 103, 104 now form a pair.

It will be understood that the invention is not limited to the embodiments above-described and various modifications and improvements can be made without departing from the concepts described herein. Except where mutually exclusive, any of the features may be employed separately or in combination with any other features, and the disclosure extends to and includes all combinations and sub-combinations of one or more features described herein.

### LIST OF REFERENCE SIGNS

1 Primary sliding surface
2 First secondary sliding surface
3 Second secondary sliding surface
4 Filling
5 Lubricant duct
6 Detection device
7 Tooth, phonic wheel
8 Sensor device in planetary gear box
9 Main axis of rotation
10 Gas turbine engine
11 Core engine
12 Air intake
14 Low pressure compressor
15 High pressure compressor
16 Combustion device
17 High pressure turbine
18 Bypass thrust nozzle
19 Low pressure turbine
20 Core thrust nozzle
21 Nacelle
22 Bypass duct
23 Fan
24 Stationary supporting structure
26 Shaft
27 Interconnecting shaft
28 Sun gear
30 Gear box
32 Planet gears
34 Planet carrier
36 Linkage
38 Ring gear
40 Linkage
100 Plain bearing device
101 First structural element
102 Second structural element
103 Third structural element
104 Fourth structural element
105 Conductor loop
110 Coupling means
R1 First relative rotational movement
R2 Second relative rotational movement
S Signal of a detection device
T Signal

1. A plain bearing device having a primary sliding surface between a first pair of concentrically arranged structural elements, wherein, in a normal operating state, a relative rotational movement between the structural elements along the primary sliding surface is possible,
wherein
at least one secondary sliding surface between a second pair of concentrically arranged structural elements, wherein a coupling means, in the normal operating state, prevents a relative rotational movement between the second pair of structural elements, and wherein, if a predeterminable event occurs, the coupling means is automatically releasable, such that a relative rotational movement between the second pair of structural elements along the at least one secondary sliding surface is made possible.

2. The plain bearing device according to claim 1, wherein the predeterminable event for the release of the coupling means is a deficiency in a lubricant supply to the primary sliding surface, a temperature increase, an increase in the acting torque and/or an at least partial running-dry of the primary sliding surface, wherein the event occurs over a predefined length of time.

3. The plain bearing device according to claim 1, wherein the coupling means has at least one predetermined breaking point which releases in the event of an exceedance of a particular torque acting thereon, such that a relative rotational movement between the structural elements along the at least one secondary sliding surface is possible.

4. The plain bearing device according to claim 1, wherein the coupling means has at least one punctiform, axially linear and/or areal connecting point between the structural elements across the at least one secondary sliding surface.

5. The plain bearing device according to claim 1, wherein the primary sliding surface is arranged between a first and a second concentrically arranged structural element, and the at least one secondary sliding surface is arranged concentrically between the second structural element and a third structural element situated further to the inside.

6. The plain bearing device according to claim 1, wherein a filling as coupling means and/or for emergency lubrication after the occurrence of the event is arranged between the structural elements in the region of the at least one secondary sliding surface.

7. The plain bearing device according to claim 6, wherein the filling has graphite, ceramic, bearing bronze and/or a polymer, in particular Teflon.

8. The plain bearing device according to claim 1, wherein the primary sliding surface and the at least one secondary sliding surface are connected via at least one common lubricant duct.

9. The plain bearing device according to claim 8, wherein the at least one lubricant duct extends radially outwards from the interior of the plain bearing device.

10. The plain bearing device according to claim 1, wherein a detection device for a relative rotational movement along the at least one secondary sliding surface and/or a mechanical failure of the coupling means.

11. The plain bearing device according to claim 10, wherein the detection device is coupled at least to a sensor which is designed as an inductive, capacitive, acoustic, microwave or optical sensor.

12. A method for operating a plain bearing device having a primary sliding surface between a first pair of concentrically arranged structural elements, wherein, in a normal operating state, a relative rotational movement between the structural elements along the primary sliding surface occurs,
wherein
a) at least one secondary sliding surface between a second pair of concentrically arranged structural elements, wherein, in the normal operating state, a relative rotational movement between the second pair of structural elements is prevented, and wherein
b) if a predeterminable event occurs, the coupling means is released in targeted and automatic fashion, such that a relative rotational movement between the second pair of structural elements along the at least one secondary sliding surface occurs.

13. The method according to claim 12, wherein the event for the release of the coupling means is a deficiency in a lubricant supply to the primary sliding surface, a temperature increase, an increase in the acting torque and/or an at least partial running-dry of the primary sliding surface, wherein the event occurs in particular over a predefined length of time.

14. The method according to claim 12, wherein a filling for emergency lubrication is arranged between the structural elements in the region of the at least one secondary sliding surface, wherein, after the occurrence of the event, a lubricating film builds up on the at least one secondary sliding surface.

15. The method according to claim 12, wherein a relative rotational movement along the at least one secondary sliding surface and/or a mechanical failure of the coupling means is detected by a detection means, and a corresponding signal is output to a control device.

16. A gas turbine engine for an aircraft, which gas turbine engine comprises the following:
a core engine comprising a turbine, a compressor, and a core shaft connecting the turbine to the compressor;
a fan, which is positioned upstream of the core engine, wherein the fan comprises a plurality of fan blades; and
a gear box, which can be driven by the core shaft, wherein the fan can be driven by means of the gear box at a lower speed than the core shaft, wherein the gear box has at least one plain bearing device having the features of claim 1.

17. The gas turbine engine according to claim 16, wherein the gear box is designed as a planetary gear box, wherein all or some of the planet gears are mounted on the planet carrier by means of a plain bearing device.

18. The gas turbine engine according to claim 16, wherein the planetary gear box is coupled to a sensor device which monitors the movement of the planet gears and of the plain bearing devices thereof.
